(19) United States
(12) Patent Application Publication
(10) Pub. No.: US 2026/0353059 A1
(43) Pub. Date: Nov. 5, 2026

(54) COVERAGE WINDOW UPDATE DUE TO USER EQUIPMENT MOVEMENT WITHIN TRACKING AREA

(71) Applicant: Nokia Technologies Oy, Espoo (FI)

(72) Inventors: Mads LAURIDSEN, Aalborg (DK); Srinivasan SELVAGANAPATHY, Bangalore (IN); Ping YUAN, Beijing (CN)

(21) Appl. No.: 19/116,318

(22) PCT Filed: Sep. 29, 2022
(86) PCT No.: PCT/CN2022/122417

§ 371 Date: Mar. 27, 2025

(51) Int. Cl. H04W 8/12; H04W 64/00; H04W 68/02

(52) U.S. Cl. CPC H04W 8/12; H04W 64/006; H04W 68/02

(57) ABSTRACT

Various example embodiments relate to devices, methods, apparatuses and computer readable media for coverage window update due to user equipment movement within a tracking area during discontinuous coverage. A terminal device may be configured to detect movement of the terminal device from a first cell in a tracking area to a second cell in the tracking area, and report coverage related information of the terminal device to a network device in response to the movement of the terminal device from the first cell to the second cell.

### RELATED APPLICATION

This application claims priority to PCT Patent Application No. PCT/CN2022/122417, filed 29 Sep. 2022, which is incorporated herein by reference in its entirety.

### TECHNICAL FIELD

Various example embodiments described herein generally relate to communication technologies, and more particularly, to devices, methods, apparatuses and computer readable media for coverage window update due to user equipment (UE) movement within a tracking area (TA) during discontinuous coverage.

### BACKGROUND

Certain abbreviations that may be found in the description and/or in the figures are herewith defined as follows:
3GPP 3rd Generation Partnership Project
AMF Access and Mobility management Function
CN Core Network
eDRX enhanced Discontinuous Reception
eMTC enhanced Machine-Type Communication
LEO Low Earth Orbit
LTE Long Term Evolution
MME Mobility Management Entity
NB-IOT Narrow Band Internet of Things
NTN Non-Terrestrial Network
PSM Power Save Mode
RAN Radio Access Network
RRC Radio Resource Control
SIB System Information Block
TA Tracking Area
TAU Tracking Area Update

3GPP has developed support for Narrow Band Internet of Things (NB-IoT) and enhanced Machine-Type Communication (eMTC) over a non-terrestrial network (NTN). For low cost developments of the NTN, a sparse satellite constellation using low earth orbit (LEO) satellites is envisioned. Compared to geostationary satellites, the LEO satellites have lower cost and shorter delay, but because the LEO satellites move with a high speed relative to Earth, coverage for a given place on Earth would be discontinuous.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, an example embodiment of a terminal device is provided. The terminal device may comprise at least one processor and at least one memory storing instructions. The instructions may, when executed by the at least one processor, cause the terminal device at least to detect movement of the terminal device from a first cell in a tracking area to a second cell in the tracking area, and to report coverage related information of the terminal device to a network device in response to the movement of the terminal device from the first cell to the second cell.

In an example embodiment, the coverage related information of the terminal device may comprise at least one of the following: an identity of the second cell, a location of the terminal device, or a coverage window determined for the terminal device in the second cell.

In an example embodiment, the coverage related information of the terminal device is reported to the network device in a case where the second cell has a coverage window different from the coverage window of the first cell, or different from the coverage window of a third cell where a pending paging for the terminal device is expected.

In an example embodiment, the coverage related information of the terminal device may be reported to the network device in a case where the terminal device has a pending paging.

In an example embodiment, an indication of the pending paging for the terminal device may be received in a radio resource control connection release message, a radio resource control connection release with suspension message or a system information broadcast message.

In an example embodiment, the indication of the pending paging for the terminal device may comprise information of one or more cells or geographical areas for the pending paging.

In an example embodiment, the coverage related information of the terminal device may be reported via a small data transmission procedure, an early data transmission procedure or a random access procedure.

In an example embodiment, the at least one memory may further store instructions that, when executed by the at least one processor, cause the terminal device at least to monitor for a paging in a coverage window determined at least partially based on the coverage related information for the terminal device.

In an example embodiment, the network device may comprise a radio access network device or a core network device. The core network device may comprise a mobility management entity or an access and mobility management function node.

In a second aspect, an example embodiment of a radio access network device is provided. The radio access network device may comprise at least one processor and at least one memory storing instructions. The instructions may, when executed by the at least one processor, cause the radio access network device at least to receive mobility information of a terminal device, to receive from a core network device a paging message for the terminal device along with information of the last serving cell of the terminal device or a predicted coverage window for the last serving cell, to estimate one or more cells where the terminal device is located based on the mobility information, and to page the terminal device in the estimated one or more cells and the last serving cell. The one or more cells have a coverage window prior to the predicted coverage window of the last serving cell.

In an example embodiment, the at least one memory may further store instructions that, when executed by the at least one processor, cause the radio access network device at least to receive a paging response from the terminal device, the paging response including movement information of the terminal device, and to predict a next coverage window for paging the terminal device based on the received movement information.

In an example embodiment, the mobility information may include a mobility profile of the terminal device which indicates at least one of the following: whether the terminal device is a mobile device or a stationary device, where the terminal device is deployed, or a route along which the terminal device moves. The movement information may include at least one of the following: a moving speed, a moving direction, a moving trajectory, a destination location, a planned routine to the destination location, or one or more waypoints on the routine.

In a third aspect, an example embodiment of a terminal device is provided. The terminal device may comprise at least one processor and at least one memory storing instructions. The instructions may, when executed by the at least one processor, cause the terminal device at least to receive a paging message from a radio access network device, and transmit a paging response to the radio access network device. The paging response may include movement information of the terminal device.

In an example embodiment, the at least one memory may further store instructions that, when executed by the at least one processor, cause the terminal device at least to transmit mobility information to the radio access network device when the terminal device initially connects to the radio access network device.

In an example embodiment, the mobility information may include a mobility profile of the terminal device which indicates at least one of the following: whether the terminal device is a mobile device or a stationary device, where the terminal device is deployed, or a route along which the terminal device moves. The movement information may include at least one of the following: a moving speed, a moving direction, a moving trajectory, a destination location, a planned routine line to the destination location, or one or more waypoints on the routine line.

In a fourth aspect, an example embodiment of a method is provided. The method may comprise detecting movement of a terminal device from a first cell in a tracking area to a second cell in the tracking area, and reporting coverage related information of the terminal device to a network device in response to the movement of the terminal device from the first cell to the second cell.

In an example embodiment, the coverage related information of the terminal device may comprise at least one of the following: an identity of the second cell, a location of the terminal device, or a coverage window determined for the terminal device in the second cell.

In an example embodiment, the coverage related information of the terminal device may be reported to the network device in a case where the second cell has a coverage window different from the coverage window of the first cell, or different from the coverage window of a third cell where a pending paging for the terminal device is expected.

In an example embodiment, the coverage related information of the terminal device may be reported to the network device in a case where the terminal device has a pending paging.

In an example embodiment, an indication of the pending paging for the terminal device may be received in a radio resource control connection release message, a radio resource control connection release with suspension message or a system information broadcast message.

In an example embodiment, the indication of the pending paging for the terminal device may comprise information of one or more cells or geographical areas for the pending paging.

In an example embodiment, the coverage related information of the terminal device may be reported via a small data transmission procedure, an early data transmission procedure or a random access procedure.

In an example embodiment, the method may further comprise monitoring for a paging in a coverage window determined at least partially based on the coverage related information for the terminal device.

In an example embodiment, the network device may comprise a radio access network device or a core network device, and the core network device may comprise a mobility management entity or an access and mobility management function node.

In a fifth aspect, an example embodiment of a method is provided. The method may comprise receiving at a radio access network device mobility information of a terminal device, receiving from a core network device a paging message for the terminal device along with information of the last serving cell of the terminal device or a predicted coverage window for the last serving cell, determining one or more cells where the terminal device is located, the one or more cells being estimated based on the mobility information of the terminal device and having a coverage window prior to the predicted coverage window of the last serving cell, and paging the terminal device in the estimated one or more cells and the last serving cell.

In an example embodiment, the method may further comprise receiving a paging response from the terminal device, the paging response including movement information of the terminal device, and predicting a next coverage window for paging the terminal device based on the received movement information.

In an example embodiment, the mobility information includes a mobility profile of the terminal device which indicates at least one of the following: whether the terminal device is a mobile device or a stationary device, where the terminal device is deployed, or a route along which the terminal device moves. The movement information includes at least one of the following: a moving speed, a moving direction, a moving trajectory, a destination location, a planned routine line to the destination location, or one or more waypoints on the routine line.

In a sixth aspect, an example embodiment of a method is provided. The method may comprise receiving at a terminal device, a paging message from a radio access network device, and transmitting a paging response to the radio access network device, the paging response including movement information of the terminal device.

In an example embodiment, the method may further comprise transmitting mobility information to the radio access network device when the terminal device initially connects to the radio access network device.

In an example embodiment, the mobility information includes a mobility profile of the terminal device which indicates at least one of the following: whether the terminal device is a mobile device or a stationary device, where the terminal device is deployed, or a route along which the terminal device moves. The movement information includes at least one of the following: a moving speed, a moving direction, a moving trajectory, a destination location, a planned routine line to the destination location, or one or more waypoints on the routine line.

In a seventh aspect, an example embodiment of an apparatus is provided. The apparatus may comprise means for detecting at a terminal device movement of the terminal device from a first cell in a tracking area to a second cell in the tracking area, and means for reporting coverage related information of the terminal device to a network device, in response to the movement of the terminal device from the first cell to the second cell.

In an eighth aspect, an example embodiment of an apparatus is provided. The apparatus may comprise means for receiving at a radio access network device, mobility information of a terminal device, means for receiving from a core network device, a paging message for the terminal device, along with information of the last serving cell of the terminal device or a predicted coverage window for the last serving cell, means for determining one or more cells where the terminal device is located, the one or more cells being estimated based on the mobility information of the terminal device and having a coverage window prior to the predicted coverage window of the last serving cell, and means for paging the terminal device in the estimated one or more cells and the last serving cell.

In a ninth aspect, an example embodiment of an apparatus is provided. The apparatus may comprise means for receiving at a terminal device, a paging message from a radio access network device, and means for transmitting a paging response to the radio access network device, the paging response including movement information of the terminal device.

In a tenth aspect, an example embodiment of a computer readable medium is provided. The computer readable medium may comprise instructions which, when executed by an apparatus, cause the apparatus to perform at least the following: detecting at a terminal device movement of the terminal device from a first cell in a tracking area to a second cell in the tracking area, and reporting coverage related information of the terminal device to a network device in response to the movement of the terminal device from the first cell to the second cell.

In an eleventh aspect, an example embodiment of a computer readable medium is provided. The computer readable medium may comprise instructions which, when executed by an apparatus, cause the apparatus to perform at least the following: receiving at a radio access network device mobility information of a terminal device, receiving from a core network device a paging message for the terminal device along with information of the last serving cell of the terminal device or a predicted coverage window for the last serving cell, estimating one or more cells where the terminal device is located based on the mobility information, the one or more cells having a coverage window prior to the predicted coverage window of the last serving cell, and paging the terminal device in the estimated one or more cells and the last serving cell.

In a twelfth aspect, an example embodiment of a computer readable medium is provided. The computer readable medium may comprise instructions which, when executed by an apparatus, cause the apparatus to perform at least the following: receiving at a terminal device a paging message from a radio access network device, and transmitting a paging response to the radio access network device, the paging response including movement information of the terminal device.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 is a schematic diagram illustrating an example communication network in which example embodiments of the present disclosure may be implemented.

FIG. 2 is a schematic diagram illustrating coverage windows determined for different cells.

FIG. 3 is a flowchart illustrating a method for coverage related information update in accordance with an example embodiment of the present disclosure.

FIG. 4 is a message flow diagram illustrating a paging process in accordance with an example embodiment of the present disclosure.

FIG. 5 is a block diagram illustrating an apparatus in accordance with an example embodiment of the present disclosure.

FIG. 6 is a block diagram illustrating an apparatus in accordance with an example embodiment of the present disclosure.

FIG. 7 is a block diagram illustrating an apparatus in accordance with an example embodiment of the present disclosure.

FIG. 8 is a block diagram illustrating devices in a communication system in accordance with an example embodiment of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

As used herein, the term “network device” may refer to a radio access network (RAN) device or a core network (CN) device. The RAN device may include for example a base station that can provide cells or coverage, through which terminal devices can access the network or receive services. The base station may be implemented as an evolved node B (eNB), a next generation eNB (ng-eNB), a next generation node B (gNB), or a beyond 5G base station. The base station may be embodied as a macro base station, a relay node, or a low power node such as a pico base station or a femto base station. The base station may consist of several distributed network units, such as a central unit (CU), one or more distributed units (DUs), one or more remote radio heads (RRHs) or remote radio units (RRUs). The number and functions of these distributed units depend on the selected split RAN architecture. The base station may be deployed on the ground or in the sky, for example on a satellite, a high altitude platform station, an unmanned aircraft system, a balloon, an airplane, and/or the like. The core network device may include a network function (NF) node implemented in a long term evolution (LTE) core network known as evolved packet core (EPC) or in a 5G core network known as 5G Core (5GC).

As used herein, the term “terminal device” or “user equipment” (UE) may refer to any entities or devices that can wirelessly communicate with the network devices or with each other. Examples of the terminal device can include a mobile phone, a mobile terminal (MT), a mobile station (MS), a subscriber station (SS), a portable subscriber station (PSS), an access terminal (AT), a computer, a wearable device, an on-vehicle communication device, a machine type communication (MTC) device, a D2D communication device, a V2X communication device, a sensor and the like. The term “terminal device” can be used interchangeably with a UE, a user terminal, a mobile terminal, a mobile station, or a wireless device.

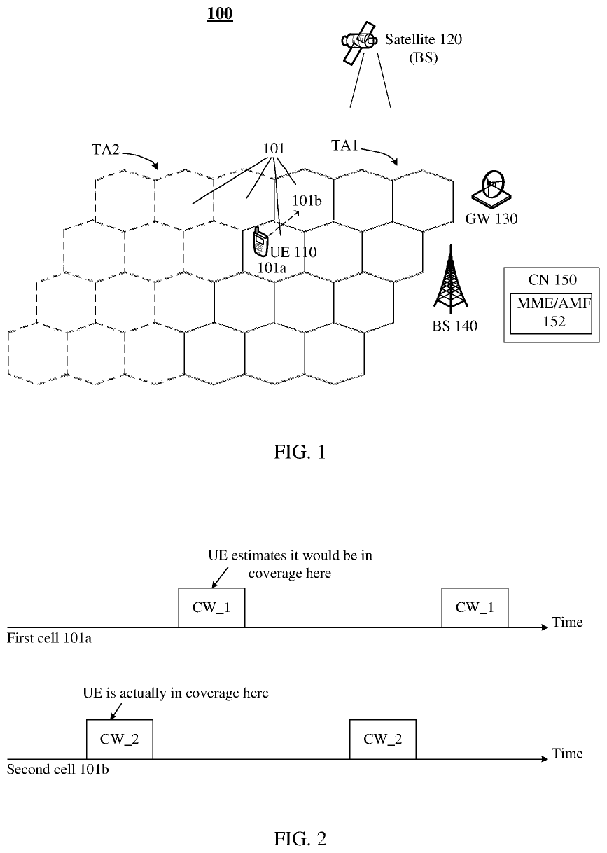

FIG. 1 is a schematic diagram illustrating an example communication network 100 in which example embodiments of the present disclosure may be implemented. The communication network 100 may form a part of a larger network like a cellular communication network. Referring to FIG. 1, the communication network 100 may be implemented as a non-terrestrial network (NTN) including one or more user equipment (UE) devices 110 (one is shown in FIG. 1) and one or more satellites 120 (one is shown in FIG. 1). The satellite 120 may be a low Earth orbit (LEO) satellite, a geostationary (GEO) satellite and any satellite in between GEO and LEO altitudes, or it may be replaced by e.g. an airplane, a balloon, a high altitude platform station, an unmanned aircraft system, etc.

The satellite 120 may be implemented as a regenerative satellite or a transparent satellite. The regenerative satellite may communicate with the UE 110 via a service link and communicate with a gateway 130 on the ground (not shown) via a feeder link. The payload of the regenerative satellite may include a base station (BS) or at least a part of a base station to perform at least a part of functionalities of the base station. For example, if the satellite 120 includes a 5G NR base station named gNB onboard, the NR-Uu radio interface may be implemented on the service link, and the N2/N3 interface may be implemented on the feeder link. The regenerative satellite may implement regeneration of signals received from the UE 110 and the gateway 130 on the ground. Optionally, the satellite 120 may further communicate with other satellites via an inter satellite link (ISL). The transparent satellite acts as an analogue radio frequency repeater for both the feeder and service links. For example, the transparent satellite simply repeats NR-Uu radio interface from the feeder link to the service link. The base station (e.g., the base station 140 shown in FIG. 1) is deployed on the ground and it communicates with UEs via the satellite 120. With the satellite 120, the NTN 100 can extend network coverage to places without any terrestrial infrastructures.

In the present disclosure, the satellite 120 is also referred to as the base station 120. It would be appreciated that reference to the term “base station” may include the base station at least partially deployed on the satellite (i.e., the regenerative satellite) and the base station deployed on the ground communicating with UEs via satellite (i.e., the transparent satellite).

The gateway 130 may provide interconnections to terrestrial infrastructures including for example a base station 140 and a core network (CN) 150. The core network 150 may be implemented as an evolved packet core (EPC) for LTE, a 5G core (5GC) for 5G New Radio (NR), or a core network for a future network. FIG. 1 also shows a mobility management entity (MME) 152 in the EPC or an access and mobility management function (AMF) 152 in the 5GC.

The UE 110 may camp in a cell 101. FIG. 1 shows a plurality of cells 101 with a hexagon honeycomb shape, but the cells 101 may also have any other shapes like a circular or ellipse shape. The term “cell” may refer to a particular geographical coverage area identified by a global cell identity (ID), and multiple cells 101 may be grouped into a tracking area (TA) which has a tracking area code (TAC) that is unique within a public land mobile network (PLMN). The PLMN identity and the TAC may be combined to obtain a globally unique number known as tracking area identity (TAI). In 5G NR, multiple tracking areas may be further grouped into a registration area. FIG. 1 shows a first tracking area TA1 (in solid line) and a second tracking area TA2 (in dashed line) as an example. Assume that the UE 110 moves from a cell in the first tracking area TA1 to a cell in the second tracking area TA2. In 4G LTE, if the second tracking area TA2 is a new TA that is not in a list of TAs that the UE 110 registered with the network, the UE 110 may perform a tracking area update (TAU) procedure to update the MME 152 in the LTE core network 150 (i.e., EPC). In 5G NR, if the second tracking area TA2 belongs to a different registration area than the first tracking area TA1, the UE 110 may perform a registration area update procedure to update the AMF 152 in the 5G core network 150 (i.e., 5GC).

In a sparse satellite constellation deployment of the NTN network 100, a discontinuous coverage scenario would be expected due to the limited number of satellites 120. For a given place on Earth, the time between coverage opportunities may be tens of minutes or even hours. To support the discontinuous coverage, the satellite 120 may provide satellite assistance information via system information broadcast e.g., in a system information block Type 32 (SIB32) to the UE 110. The satellite assistance information may include for example satellite ephemeris and related parameters for up to four target satellites. Based on the satellite assistance information, the UE 110 and/or the network can predict future coverage windows (also known as visibility duration) for the UE 110 at a given cell/place. The network may further configure the UE 110 with an enhanced/extended discontinuous reception (eDRX) and/or power save mode (PSM) configuration aligned to the predicted coverage windows, which allows the UE 110 to monitor for paging during the coverage windows and remain inactive or in an idle/sleep mode when there is no cell coverage available within an interval between the coverage windows.

FIG. 2 illustrates an example of coverage windows determined for different cells. As shown in FIG. 2, a first cell 101a and a second cell 101b may have different coverage windows CW_1 and CW_2, respectively. It is assumed that the first cell 101a and the second cell 101b belong to a same tracking area (TA), e.g., the TA1 as shown in FIG. 1, and the first cell 101a is the last serving cell for the UE 110. When the UE 110 moves from the first cell 101a into the second cell 101b, the UE 110 would not perform a tracking area update (TAU) procedure or a registration area update procedure to inform the network of its new cell because the first cell 101a and the second cell 101b belong to the same TA. Then the network would still page the UE 110 in the coverage windows CW_1 for the first cell 101a (the last serving cell of the UE 110), but the UE 110 cannot receive the paging because service for the second cell 101b is available in the coverage window CW_2.

Conventionally, if the network does not receive a paging response for a predetermined number of paging attempts, the network may escalate the paging to the entire TA or even the entire TA list (TAL) that the UE registered with the network and attempt to page the UE 110 during multiple coverage windows. The LEO satellite's user beam has a footprint of 100-1000 km wide, therefore the escalated paging in multiple cells would impact a large number of UEs.

At the UE side, if the UE 110 fails to detect a cell coverage in the estimated coverage window, the UE 110 may extend the cell search outside the estimated window. However, the time interval between coverage windows may be large up to several hours, e.g., from the first CW_1 to the second CW_2 in FIG. 2. Then the UE 110 has to spend a long time for the cell search until a next coverage opportunity comes.

In FIG. 2, the different coverage windows CW_1, CW_2 are illustrated to occur at totally different time periods, but in practice it is possible that two cells may have fully or partially overlapping coverage windows, for example when the two cells correspond to geographical areas not far away from each other.

According to aspects of the present disclosure, a mechanism for coverage window update is proposed. In some example embodiments, the UE may update coverage related information to the network when the UE moves from a first cell to a second cell within the same TA, thus the network can page the UE at the right time. In other example embodiments, the network may adjust the paging time based on UE mobility information, and the UE may report its movement to the network so that the network can predict a coverage window for a next paging. The example embodiments can increase success chance of the paging, avoid or reduce escalating the paging to the entire TA or TA list (TAL), and also minimize the paging delay (i.e., delay from the network determining to page the UE until the UE receiving and responding to the paging).

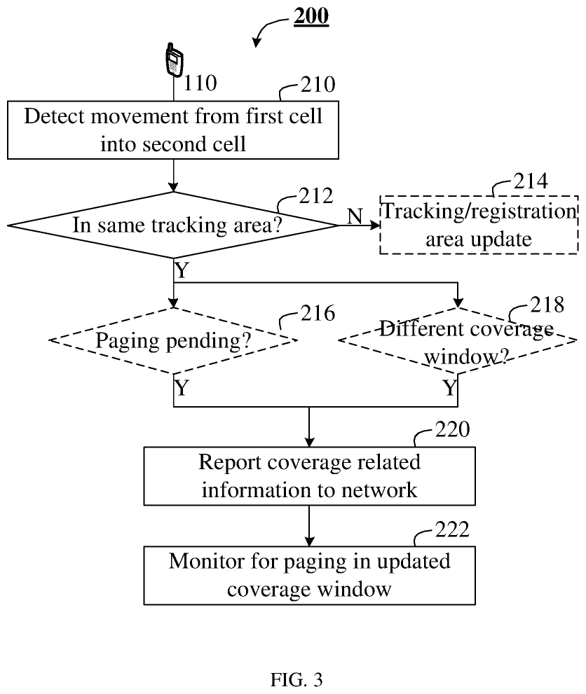

FIG. 3 is a flowchart illustrating a method 200 for coverage related information update in accordance with an example embodiment of the present disclosure. The method 200 may be performed at a user equipment (UE) like the UE 110 discussed above. In an example embodiment, the UE 110 may include a plurality of means, modules or elements for performing steps in the method 200. The means, modules and elements may be implemented in various manners including but not limited to for example software, hardware, firmware or any combination thereof.

Referring to FIG. 3, at 210, the UE 110 may detect movement from a first cell 101a to a second cell 101b. In an example embodiment, the UE 110 can acquire a physical cell identity (PCI) from primary and secondary synchronization signals PSS, SSS. If the PCI changes, the UE 110 can determine that it has moved into a new cell. In another example embodiment, the UE 110 may detect the movement by monitoring for system information broadcast from the satellite/base station 120. For example, the UE 110 can determine which cell it is currently in from a system information block Type 1 (SIB1) received from the base station 120. The SIB1 includes, among others, a cell identity (ID), a tracking area code (TAC) and a public land mobile network (PLMN) identity. If the current cell (the second cell 101b) is different from the cell the UE 110 was previously located (the first cell 101a), the UE 110 can determine that it has moved from the first cell 101a to the second cell 101b. In yet another example embodiment, the UE 110 may detect its movement by utilizing a positioning procedure. For example, the UE 110 may be equipped with an inertial sensor or a global navigation satellite system (GNSS) module to detect its location coordinates. The UE 110 also has knowledge of geographical area coordinates of respective cells or other satellite assistance information e.g., SIB31 and SIB32. Then the UE 110 can determine if it has moved from the first cell 101a to the second cell 101b based on its location coordinates.

At 212, the UE 110 may determine whether the first cell 101a and the second cell 101b belong to a same tracking area (TA). Similar to the cell ID, the UE 110 can receive the tracking area code (TAC) in the system information block Type 1 (SIB1) from the base station 120. The UE 110 may compare the TAC associated with the first cell 101a and the TAC associated with the second cell 101b to determine whether the first cell 101a and the second cell 101b are included in the same TA. In another example embodiment, the UE 110 may maintain a list of cells belonging to the TA where it is currently located. If the second cell 101b is not included in the cell list of the current TA, the UE 110 can determine that the second cell 101b belongs to a new TA different from the current TA including the first cell 101a.

If the second cell 101b is in a new TA different from the previous TA including the first cell 101a, at 214, the UE 110 may optionally perform a tracking area update (TAU) procedure to inform the network that the UE 110 is in the second cell 101b and to update a mobility management entity (MME) 152 in the LTE core network 150 (i.e., the EPC) for the UE 110. In an example, the UE 110 may perform the TAU procedure when the new TA including the second cell 101b is not in the TA list the UE 110 registered with the network. The TA list may be maintained at the MME 152 and the UE 110 may receive the TA list in an attach procedure or in a previous TAU procedure. In another example embodiment where the core network 150 is implemented as a 5G core (5GC) and the new TA including the second cell 101b belongs to a different registration area than the previous TA including the first cell 101a, the UE 110 may perform a registration area update procedure at 214 to inform the network that the UE 110 is in the second cell 101b and to update an access and mobility management function (AMF) 152 in the core network 150 for the UE 110.

If the second cell 101b is in the same TA as the first cell 101a, the UE 110 may report coverage related information to the network at 220, which will be described in detail below.

In an example embodiment, if the second cell 101b is in the same TA as the first cell 101a, the UE 110 may optionally determine at 216 whether there is a paging pending for the UE 110. For example, the base station 120 may indicate in a radio resource control (RRC) connection release message, an RRC connection release with suspension message or a system information broadcast message that it intends to page the UE 110. The base station 120 may further indicate one or more cells or geographical areas where it will page the UE 110, which may include the last serving cell of the UE 110 or any other cells. In another example, the base station 120 may simply indicate that there is a pending paging for a certain cell without specifying which UE the pending paging is for. Then if the UE 110 received the indication and now it is in the certain cell, the UE 110 will monitor for the pending paging. If there is the paging pending for the UE 110, the UE 110 may report the coverage related information to the network at 220 to help the network page the UE 110 at the right time. Otherwise, the UE 110 may not report the coverage related information to the network.

Optionally, at 218, the UE 110 may determine whether the second cell 101b has a coverage window different from the coverage window of the first cell 101a, or different from the coverage window of one or more third cells where a pending paging for the UE 110 is expected. The one or more third cells may or may not include the first cell 101a. The UE 110 may determine the coverage windows of the respective cells based on satellite assistance information received in the SIB32 from the network or based on dedicated signaling (e.g., RRC signaling) received from the network. The satellite assistance information may include for example satellite ephemeris and related parameters for up to four target satellites, and the satellite ephemeris may define satellite's posture, position, movement vector, orbit, etc. The UE 110 may apply algorithms to estimate the coverage window based on the satellite assistance information and cell locations. In another example, the UE 110 may receive information of the coverage windows for the respective cells from the network, e.g., in the system information broadcast.

If the coverage window of the second cell 101b is the same as (fully or partially overlaps with) the coverage window of the first cell 101a, when the base station 120 pages the UE 110 in the coverage window for the first cell 101a, the UE 110 which has moved from the first cell 101a into the second cell 101b would have a chance to receive the paging. If the coverage window of the second cell 101b is different from (before or after, see FIG. 2) the coverage window of the first cell 101a, the UE 110 may not receive the paging in the coverage window of the first cell 101a. Therefore, when the UE 110 determines at 218 that the coverage window of the second cell 101b is different from the coverage window of the first cell 101a, the UE 110 may report the coverage related information to the network at 220. Similarly, when the UE 110 determines at 218 that the coverage window of the second cell 101b is different from the coverage window of the one or more third cells where a pending paging for the UE 110 is expected, the UE 110 may also report the coverage related information to the network at 220.

In an example embodiment, if the coverage window of the second cell 101b is shortly after the coverage window of the first cell 101a and the UE 110 does not receive the paging in the coverage window of the first cell 101a, the base station 120 may escalate the paging to the entire TA or TA list. Then the UE 110 may have a chance to receive the paging in the coverage window of the second cell 101b shortly after the coverage window of the first cell 101a if the UE 110 extends its paging monitoring time window, and the UE 110 may not report the coverage related information to the network at 220. Taking into account this situation, in an example, the UE 110 may report the coverage related information to the network when the coverage window of the second cell 101b is different from and before the coverage window of the first cell 101a or the one or more third cells where the pending paging for the UE 110 is expected. In an example embodiment, the network may configure the conditions for the UE 110 to trigger the report of the coverage related information.

Although FIG. 3 shows the steps 216, 218 in parallel so that if any step 216 or 218 has a positive outcome, the method 200 can proceed to the step 220. In another example, it would be appreciated that the steps 216, 218 may be performed in sequence (from step 216 to step 218 or from step 218 to step 216) and when both steps 216 and 218 have a positive outcome, the method 200 can proceed to the step 220.

At 220, the UE 110 may report the coverage related information to the network. The coverage related information may explicitly or implicitly indicate an actual coverage window for the UE 110 in the second cell 101b. In an example embodiment, the coverage related information may include at least one of the following: a coverage window determined for the UE 110 in the second cell 101b, an identity of the second cell 101b, or a location of the UE 110. As discussed above, the coverage window for the UE 110 in the second cell 101b may be determined based on the satellite assistance information received from the network and the location of the UE 110 or the second cell 101b. The UE 110 may calculate and report the coverage window to the network, or the UE 110 may report its location or the cell information to the network and the network may calculate the coverage window for the UE 110 based on the received information.

The UE 110 may report the coverage related information to the base station 120 or to the MME or AMF 152 in the core network 150. In an example embodiment, the UE 110 may report the coverage related information to the base station 120 so that the base station 120 can immediately redirect the paging for the UE 110 from the first cell 101a to the second cell 101b where the UE 110 is actually located.

The UE 110 may transmit the coverage related information to the network via a small data transmission (SDT) procedure, an early data transmission (EDT) procedure or a random access procedure. In the small data transmission procedure, the UE 110 may transmit the coverage related information on pre-configured uplink resources. In the early data transmission procedure, the UE 110 may transmit the coverage related information for example in an RRCEarlyDataRequest message. In a 4-step random access procedure, the UE 110 may transmit the coverage related information for example in Message 3 (RRC Connection Request) or Message 5 (RRC Connection Setup Complete). In a 2-step random access procedure, the UE 110 may transmit the coverage related information for example in Message A (Preamble+RRC Connection Request).

At 222, the UE 110 may monitor for a paging in the coverage window of the second cell 101b. As discussed above, the coverage window of the second cell 101b may be determined based on the satellite assistance information and the coverage related information for example the location of the UE or the second cell 101b.

In the method 200 shown in FIG. 3, the UE 110 updates its coverage related information to the network when the UE 110 moves from the first cell 101a to the second cell 101b in the same tracking area. Then the network can redirect the paging for the UE 110 to the second cell 101b where the UE 110 is actually located and page the UE 110 at the right time. It can increase success chance of the paging and avoid or reduce escalating the paging to the entire TA or TA list (TAL), thereby reducing the impact on other UEs.

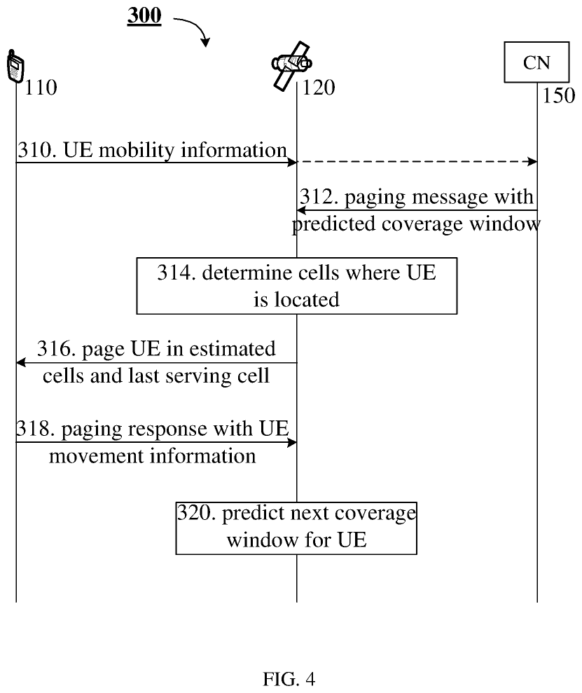

FIG. 4 illustrates a paging process 300 in accordance with an example embodiment of the present disclosure. The paging process 300 may be performed at a user equipment (UE) like the UE 110 discussed above, a base station like the base station 120 on a satellite or on Earth discussed above, and a core network (CN) like the core network (EPC or 5GC) 150 discussed above. In the paging process 300, the base station 120 can adjust paging time for the UE 110 based on UE mobility information, and the UE 110 may report its movement to the base station 120 in a paging response. The paging process 300 can increase success chance of the paging without significantly increasing the signaling overhead because the UE 110 does not need to report its movement every time it moves into a new cell.

Referring to FIG. 4, at 310, the UE 110 may send mobility information to the base station 120. The mobility information may include a mobility profile of the UE 110. For example, it may indicate the UE 110 is a mobile UE or a stationary UE. For the mobile UE, the mobility profile may further indicate where the UE is deployed, e.g., on a ship, a train, a car or a plane, so that the base station 120 can have a rough estimation about the moving speed of the UE 110. If the UE moves along a fixed route, the UE 110 may also report the route in the mobility information to the base station 120. In an example, the UE 110 may transmit the mobility information to the base station 120 when the UE 110 initially connects to the base station 120 and reports UE capabilities to the base station 120, and the base station 120 may further send the mobility information to the core network 150, e.g., to the core network device MME or AMF 152. In another example embodiment, when the core network 150 intends to page the UE 110, the core network 150, e.g., the core network device MME or AMF 152, may send the mobility information of the UE 110 to the base station 120 serving one or more cells where the UE 110 is now possibly located so that the base station 120 can estimate the location of the UE 110, which will be described below.

At 312, the base station 120 may receive a paging message for the UE 110, along with information of the last serving cell of the UE 110 or a predicted coverage window for the last serving cell, from the core network 150, e.g., from the core network device MME or AMF 152. The paging message may include for example an international mobile subscriber identity (IMSI) or a temporary mobile subscriber identity (TMSI) to identify the UE 110, and a paging cause. The core network 150 may inform the base station 120 of the last serving cell for the UE 110 and the base station 120 can determine a coverage window to page the UE 110 based on the last serving cell and the satellite assistance information, or the core network 150 may predict the coverage window for the last serving cell and directly send information of the predicted coverage window to the base station 120.

At 314, the base station 120 may estimate one or more cells where the UE 110 is located based on the mobility information of the UE 110. For example, the base station 120 may have a rough estimation of the moving speed of the UE 110 based on the mobility information received from the UE 110 or from the core network 150 at the step 310, then the base station 120 may determine one or more cells where the UE 110 is possibly located. In another example, the base station 120 may receive location estimation of the UE 110 from the core network 150 e.g., from the MME or AMF 152, at the step 314. The MME or AMF 152 may estimate one or more cells where the UE 110 is possibly located based on the mobility information of the UE 110 and inform relevant base stations to page the UE 110 in the estimated cells. In an example embodiment, the determined one or more cells having a coverage window prior to the predicted coverage window for the last serving cell of the UE 110.

At 316, the base station 120 may page the UE 110 in the estimated one or more cells and the last serving cell. In an example, the base station 120 may page the UE 110 in these cells in an order of the cells entering into coverage, and the base station 120 may page the UE 110 in multiple cells simultaneously when the multiple cells all are in coverage.

It would be appreciated that depending on the moving direction of the UE 110, the actual coverage window for the UE 110 may be earlier or later than the predicted coverage window. Therefore, the UE 110 may receive the paging from the base station 120 in the step 316 if the UE 110 moves to a cell which enters into coverage earlier than the last serving cell does, but it is also possible that the UE 110 cannot receive the paging if the UE 110 moves to a cell which enters into coverage later than the last serving cell does. In the latter case, the base station 120 does not receive a paging response from the UE 110 and it may escalate the paging to the entire TA or TA list (i.e., the registration area). Then the UE 110 may have a chance to receive the paging in a coverage window posterior to the coverage window of the last serving cell.

At 318, the UE 110 may send a paging response to the base station 120 in response to the paging received from the base station 120. The paging response may include movement information of the UE 110. For example, the movement information may include a moving speed, a moving direction, a moving trajectory, a destination location, a planned routine line to the destination location and/or one or more waypoints on the routine line. In an example embodiment, the movement information may be sent in a subsequent message.

With the movement information of the UE 110, the base station 120 may predict a next coverage window for paging the UE 110 at 320. For example, the base station 120 may predict a future location of the UE 110 and determine the coverage window based on predicted UE location and the satellite assistance information.

In the paging process 300, the UE 110 does not need to report its movement every time the UE 110 enters into a new cell. Instead, the base station 120 may estimate the location of the UE 110 and then page the UE 110 in relevant cells. It can increase success chance of the paging while the signaling overhead of the network is almost not increased.

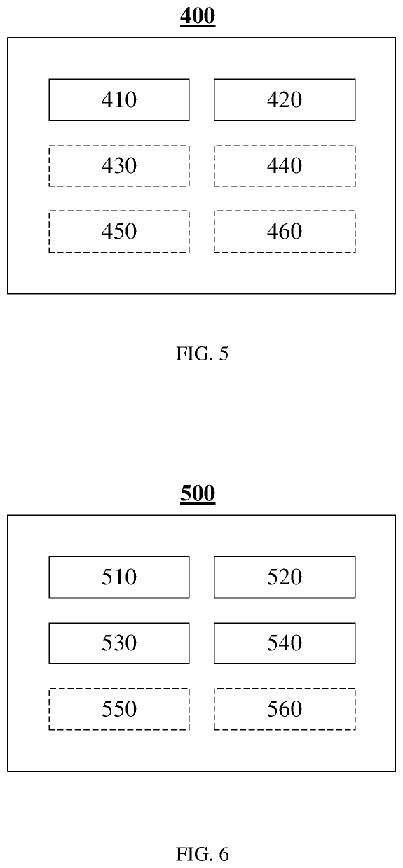

FIG. 5 is a block diagram illustrating an apparatus 400 in accordance with an example embodiment of the present disclosure. The apparatus 400 may be implemented to comprise or to form at least a part of the UE 110 discussed above to perform at least a part of operations related to the UE 110. Since the operations related to the UE 110 have been discussed above with reference to FIGS. 1-4, the blocks of the apparatus 400 will be described briefly here and details thereof may refer to the above description.

As shown in FIG. 5, the apparatus 400 may include a first means 410 for detecting movement of the UE 110 from a first cell 101a in a tracking area to a second cell 101b in the tracking area, and a second means 420 for reporting coverage related information of the UE 110 to a network device, in response to the movement of the UE 110 from the first cell 101a to the second cell 101b.

In an example embodiment, the coverage related information of the UE 110 may comprise at least one of the following: an identity of the second cell 101b, a location of the UE 110, or a coverage window determined for the UE 110 in the second cell 101b.

In an example embodiment, the apparatus 400 may further comprise a third means 430 for determining whether the second cell 101b has a coverage window different from the coverage window of the first cell 101a, or different from the coverage window of a third cell where a pending paging for the UE 110 is expected. The coverage related information of the UE 110 may be reported to the network device in a case where the coverage window of the second cell 101b is different from the coverage window of the first cell 101a or different from the coverage window of the third cell where the pending paging for the UE 110 is expected.

In an example embodiment, the apparatus 400 may further comprise a fourth means 440 for determining whether the UE 110 has a pending paging. In a case where the UE 110 has a pending paging, the UE 110 may report the coverage related information to the network device.

In an example embodiment, the apparatus 400 may further comprise a fifth means 450 for receiving an indication of the pending paging for the UE 110 from the network. The indication of the pending paging for the UE 110 may be received in a radio resource control (RRC) connection release message, in an RRC connection release with suspension message, or a system information broadcast message.

In an example embodiment, the indication of the pending paging for the UE 110 may comprise information of one or more cells or geographical areas for the pending paging.

In an example embodiment, the coverage related information of the UE 110 may be reported to the network device via an early data transmission procedure or a random access procedure.

In an example embodiment, the apparatus 400 may further comprise a sixth means 460 for monitoring for a paging in a coverage window determined at least partially based on the coverage related information for the UE 110.

In an example embodiment, the network device may comprise a radio access network device or a core network device. The core network device may comprise a mobility management entity (MME) or an access and mobility management function (AMF) node.

FIG. 6 is a block diagram illustrating an apparatus 500 in accordance with an example embodiment of the present disclosure. The apparatus 500 may be implemented to comprise or to form at least a part of a radio access network device such as the base station 120 discussed above to perform at least a part of operations related to the base station 120. Since the operations related to the base station 120 have been discussed above with reference to FIGS. 1-4, the blocks of the apparatus 500 will be described briefly here and details thereof may refer to the above description.

As shown in FIG. 6, the apparatus 500 may comprise a first means 510 for receiving mobility information of the UE 110, a second means 520 for receiving from a core network device e.g., the MME or AMF 152 a paging message for the UE 110, along with information of the last serving cell of the UE 110 or a predicted coverage window for the last serving cell, a third means 530 for determining one or more cells where the UE 110 is located, and a fourth means 540 for paging the UE 110 in the estimated one or more cells and the last serving cell. The one or more cells may be estimated based on the mobility information of the UE 110 and may have a coverage window prior to the predicted coverage window of the last serving cell.

In an example embodiment, the apparatus 500 may further comprise a fifth means 550 for receiving from the UE 110 a paging response including movement information of the UE 110, and a sixth means 560 for predicting a next coverage window for paging the UE 110 based on the received movement information.

In an example embodiment, the mobility information may include a mobility profile of the UE 110 which indicates at least one of the following: whether the UE 110 is a mobile device or a stationary device, where the UE 110 is deployed, or a route along which the UE 110 moves. The movement information may include at least one of the following: a moving speed, a moving direction, a moving trajectory, a destination location, a planned routine line to the destination location, or one or more waypoints on the routine line.

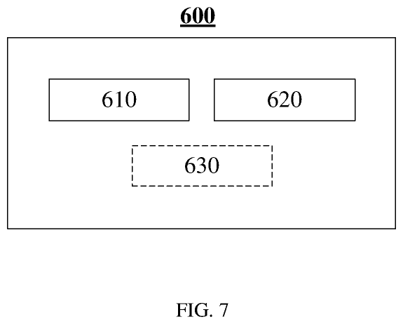

FIG. 7 is a block diagram illustrating an apparatus 600 in accordance with an example embodiment of the present disclosure. The apparatus 600 may be implemented to comprise or to form at least a part of the UE 110 discussed above to perform at least a part of operations related to the UE 110. Since the operations related to the UE 110 have been discussed above with reference to FIGS. 1-4, the blocks of the apparatus 600 will be described briefly here and details thereof may refer to the above description.

As shown in FIG. 7, the apparatus 600 may include a first means 610 for receiving a paging message from a radio access network device e.g., the base station 120, and a second means 620 for transmitting a paging response to the radio access network device. The paging response may include movement information of the UE 110.

In an example embodiment, the apparatus 600 may further comprise a third means 630 for transmitting mobility information to the radio access network device. The mobility information may be transmitted when the UE 110 initially connects to the radio access network device.

In an example embodiment, the mobility information may include a mobility profile of the UE 110 which indicates at least one of the following: whether the UE 110 is a mobile device or a stationary device, where the UE 110 is deployed, or a route along which the UE 110 moves. The movement information may include at least one of the following: a moving speed, a moving direction, a moving trajectory, a destination location, a planned routine line to the destination location, or one or more waypoints on the routine line.

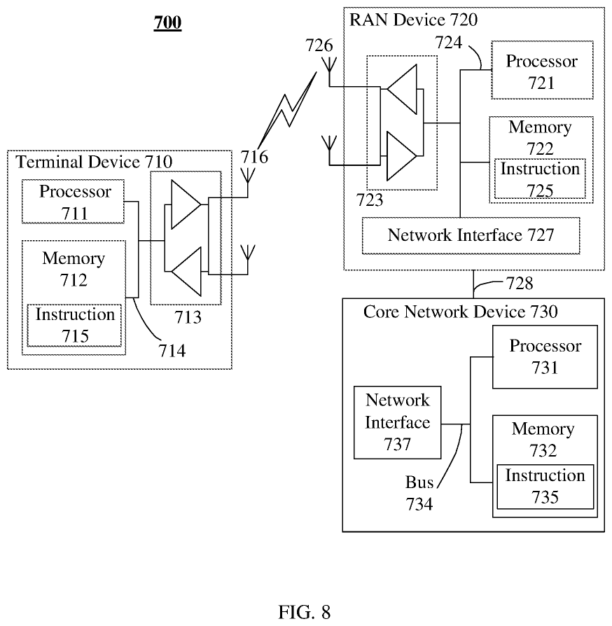

FIG. 8 is a block diagram illustrating devices in a communication system 700 in accordance with an example embodiment of the present disclosure. As shown in FIG. 8, the communication system 700 may comprise a terminal device 710 which may be implemented as the UE 110 shown in FIG. 1, a radio access network device 720 which may be implemented as the base station 120 shown in FIG. 1, and a core network device 730 which may be implemented as the MME or AMF 152 shown in FIG. 1.

Referring to FIG. 8, the terminal device 710 may comprise one or more processors 711, one or more memories 712 and one or more transceivers 713 interconnected through one or more buses 714. The one or more buses 714 may be address, data, or control buses, and may include any interconnection mechanism such as series of lines on a motherboard or integrated circuit, fiber, optics or other optical communication equipment, and the like. Each of the one or more transceivers 713 may comprise a receiver and a transmitter, which are connected to one or more antennas 716. The terminal device 710 may wirelessly communicate with the radio access network device 720 through the one or more antennas 716. The one or more memories 712 may include instructions 715 which, when executed by the one or more processors 711, may cause the terminal device 710 to perform operations and procedures relating to the UE 110 as described above.

The radio access network device 720 may comprise one or more processors 721, one or more memories 722, one or more transceivers 723 and one or more network interfaces 727 interconnected through one or more buses 724. The one or more buses 724 may be address, data, or control buses, and may include any interconnection mechanism such as a series of lines on a motherboard or integrated circuit, fiber, optics or other optical communication equipment, and the like. Each of the one or more transceivers 723 may comprise a receiver and a transmitter, which are connected to one or more antennas 726. The radio access network device 720 may operate as a base station for the terminal device 710 and wirelessly communicate with terminal device 710 through the one or more antennas 726. The one or more network interfaces 727 may provide wired or wireless communication links through which the network device 1020 may communicate with other network devices, entities, elements or functions. For example, the radio access network device 720 may communicate with the core network device 730 via backhaul connections 728. The one or more memories 722 may include instructions 725 which, when executed by the one or more processors 721, may cause the radio access network device 720 to perform operations and procedures relating to the base station 120.

The core network device 730 may comprise one or more processors 731, one or more memories 732, and one or more network interfaces 737 interconnected through one or more buses 734. The one or more buses 734 may be address, data, or control buses, and may include any interconnection mechanism such as a series of lines on a motherboard or integrated circuit, fiber, optics or other optical communication equipment, and the like. The core network device 730 may operate as a core network function node and wired or wirelessly communicate with the radio access network device 720 through one or more links. The one or more network interfaces 737 may provide wired or wireless communication links through which the core network device 730 may communicate with other network devices, entities, elements or functions. The one or more memories 732 may include instructions 735 which, when executed by the one or more processors 731, may cause the core network device 730 to perform operations and procedures relating to the MME or AMF 152 as described above.

The one or more processors 711, 721 and 731 discussed above may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 711, 721 and 731 may be configured to control other elements of the UE/radio access network device/core network device and operate in cooperation with them to implement the procedures discussed above.

The one or more memories 712, 722 and 732 may include at least one storage medium in various forms, such as a transitory memory and/or a non-transitory memory. The transitory memory may include, but not limited to, for example, a random access memory (RAM) or a cache. The non-transitory memory may include, but not limited to, for example, a read only memory (ROM), a hard disk, a flash memory, and the like. The term “non-transitory,” as used herein, is a limitation of the medium itself (i.e., tangible, not a signal) as opposed to a limitation on data storage persistency (e.g., RAM vs. ROM). Further, the one or more memories 712, 722 and 732 may include but not limited to an electric, a magnetic, an optical, an electromagnetic, an infrared, or a semiconductor system, apparatus, or device or any combination of the above.

It would be understood that blocks in the drawings may be implemented in various manners, including software, hardware, firmware, or any combination thereof. In some embodiments, one or more blocks may be implemented using software and/or firmware, for example, machine-executable instructions stored in the storage medium. In addition to or instead of machine-executable instructions, parts or all of the blocks in the drawings may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

Some exemplary embodiments further provide program instruction or instructions which, when executed by one or more processors, may cause a device or apparatus to perform the procedures described above. The program instruction for carrying out procedures of the exemplary embodiments may be written in any combination of one or more programming languages. The program instruction may be provided to one or more processors or controllers of a general purpose computer, special purpose computer, or other programmable data processing apparatus, such that the program instruction, when executed by the processor or controller, cause the functions/operations specified in the flowcharts and/or block diagrams to be implemented. The program instruction may execute entirely on a machine, partly on the machine, as a stand-alone software package, partly on the machine and partly on a remote machine or entirely on the remote machine or server.

Some exemplary embodiments further provide a computer program product or a computer readable medium having the program instruction or instructions stored therein. The computer readable medium may be any tangible medium that may contain, or store a program for use by or in connection with an instruction execution system, apparatus, or device. The machine readable medium may be a machine readable signal medium or a machine readable storage medium. A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims.

1-36. (canceled)

37. A terminal device comprising:
at least one processor; and
at least one memory storing instructions that, when executed by the at least one processor, cause the terminal device at least to:
detect movement of the terminal device from a first cell in a tracking area to a second cell in the tracking area; and
report coverage related information of the terminal device to a network device, in response to the movement of the terminal device from the first cell to the second cell.

38. The terminal device of claim 36, wherein the coverage related information of the terminal device comprises at least one of the following: an identity of the second cell, a location of the terminal device, or a coverage window determined for the terminal device in the second cell.

39. The terminal device of claim 36, wherein the coverage related information of the terminal device is reported to the network device in a case where the second cell has a coverage window different from the coverage window of the first cell, or different from the coverage window of a third cell where a pending paging for the terminal device is expected.

40. The terminal device of claim 36, wherein the coverage related information of the terminal device is reported to the network device in a case where the terminal device has a pending paging.

41. The terminal device of claim 39, wherein an indication of the pending paging for the terminal device is received in a radio resource control connection release message, a radio resource control connection release with suspension message or a system information broadcast message.

42. The terminal device of claim 41, wherein the indication of the pending paging for the terminal device comprises information of one or more cells or geographical areas for the pending paging.

43. The terminal device of claim 37, wherein the coverage related information of the terminal device is reported via a small data transmission procedure, an early data transmission procedure or a random access procedure.

44. The terminal device of claim 37, wherein the at least one memory further stores instructions that, when executed by the at least one processor, cause the terminal device at least to:
monitor for a paging in a coverage window determined at least partially based on the coverage related information for the terminal device.

45. The terminal device of claim 37, wherein the network device comprises a radio access network device or a core network device, and the core network device comprises a mobility management entity or an access and mobility management function node.

46. A radio access network device comprising:
at least one processor; and
at least one memory storing instructions that, when executed by the at least one processor, cause the radio access network device at least to:
receive mobility information of a terminal device;
receive from a core network device, a paging message for the terminal device, along with information of the last serving cell of the terminal device or a predicted coverage window for the last serving cell;
determine one or more cells where the terminal device is located, the one or more cells being estimated based on the mobility information of the terminal device and having a coverage window prior to the predicted coverage window of the last serving cell; and
page the terminal device in the estimated one or more cells and the last serving cell.

47. The radio access network device of claim 46, wherein the at least one memory further stores instructions that, when executed by the at least one processor, cause the radio access network device at least to:
receive a paging response from the terminal device, the paging response including movement information of the terminal device; and
predict a next coverage window for paging the terminal device based on the received movement information.

48. The radio access network device of claim 47, wherein the mobility information includes a mobility profile of the terminal device which indicates at least one of the following: whether the terminal device is a mobile device or a stationary device, where the terminal device is deployed, or a route along which the terminal device moves, and the movement information includes at least one of the following: a moving speed, a moving direction, a moving trajectory, a destination location, a planned routine to the destination location, or one or more waypoints on the routine.

49. A terminal device comprising:
at least one processor; and
at least one memory storing instructions that, when executed by the at least one processor, cause the terminal device at least to:
receive a paging message from a radio access network device; and
transmit a paging response to the radio access network device, the paging response including movement information of the terminal device.

50. The terminal device of claim 49, wherein at least one memory further stores instructions that, when executed by the at least one processor, cause the terminal device at least to:
transmit mobility information to the radio access network device when the terminal device initially connects to the radio access network device.

51. The terminal device of claim 50, wherein the mobility information includes a mobility profile of the terminal device which indicates at least one of the following:
whether the terminal device is a mobile device or a stationary device, where the terminal device is deployed, or a route along which the terminal device moves, and
the movement information includes at least one of the following: a moving speed, a moving direction, a moving trajectory, a destination location, a planned routine line to the destination location, or one or more waypoints on the routine line.
